(19) United States
(12) Patent Application Publication
(10) Pub. No.: US 2011/0013941 A1
(43) Pub. Date: Jan. 20, 2011

(54) COLOR ELECTROPHOTOGRAPHIC IMAGE FORMING APPARATUS

(75) Inventor: Daisuke Aoki, Numazu-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/841,844

(22) Filed: Jul. 22, 2010

Related U.S. Application Data
(63) Continuation of application No. PCT/JP2009/061736, filed on Jun. 26, 2009.

(51) Int. Cl. G03G 15/01

(52) U.S. Cl. 399/227

(57) ABSTRACT

An apparatus, which able to stop with accuracy rotary support which supports plurality of developing devices, is provided. When rotary support rotates once, phase detecting device rotates multiple number n times, and color detecting flag shades or passes color detecting sensor when rotary support is in the predetermined phase. The number is a nature number.

### CROSS REFERENCE TO RELATED APPLICATIONS

This application is a Continuation of International Application No. PCT/JP2009/061736, filed Jun. 26, 2009, which is hereby incorporated by reference herein in its entirety.

### BACKGROUND OF THE INVENTION

1. Field of the Invention

The present invention relates to a color electrophotographic image forming apparatus using a rotatable rotary support in support of a plurality of developing devices.

2. Description of the Related Art

Conventionally, a color electrophotographic image forming apparatus using a rotatable rotary support (rotary) supporting a plurality of developing devices has been known in the art. In the image forming apparatus, by rotating the rotary support, a plurality of developing devices supporting the rotary support are moved sequentially to the developing position opposed to an electrophotosensitive drum. The color electrophotographic image forming apparatus provides a sensor flag to the rotary support as means to detect the self-phase of the rotary support.

However, in late years the main body of device is getting downsized and the size of the rotary support is also becoming smaller in accordance with the downsizing. Therefore, the sensor flag detected with an optical sensor to detect phase of the rotary support will be provided at the near position from the center rotation of the rotary support compared to the conventional art. Thus, if the main body is downsized, the detected error of the phase of the rotary support by the sensor tends to be bigger compared to the conventional art.

For example, if the position of the sensor flag provided on the rotary support is 50 mm from the center rotation of the rotary support, the variation error of the detective precision of the sensor flag is twice as much, compared with the case of 100 mm. This will influence the precision to stop the developing device at the developing position to develop latent image of the electrophotosensitive drum. Thus, in accordance with the downsizing of the main body of the device, to stop the developing device to the developing position with accuracy compared with the conventional mechanism may be an issue.

Thus, the present invention provides color electrophotographic image forming apparatus which can detect phase of the rotary support which supports a plurality of developing devices with accuracy in small space.

The present invention also provides the color electrophotographic image forming apparatus which can stop the rotary support which supports a plurality of the developing device to the developing position with accuracy and implemented the downsizing.

### SUMMARY OF THE INVENTION

According to an aspect of the present invention, an apparatus includes a photosensitive member for forming an electrostatic latent image, a rotary support configured to support a plurality of developing devices for developing an electrostatic latent image, and to move a developing device to a developing position by rotation, a first member configured to rotate multiple times of natural number when the rotary support rotates once moving together with the rotary support, a rotation of the first member being detected by a first sensor, a second member configured to move together with the rotary support, the rotary support member being detected to be positioned at a predetermined phase by a second sensor and a controlling unit configured to detect a phase of the rotary support by a first signal to be output from the first sensor, and a second signal to be output from the second sensor.

### BRIEF DESCRIPTION OF THE DRAWINGS

FIG. 1 is a sectional view showing the outline configuration of laser beam printer which is an example of the image forming apparatus.

FIG. 2 is an elevation view showing the phase detective configuration of the rotary concerning the first embodiment.

FIG. 3 is a right side elevation view showing the phase detective configuration of the rotary concerning the first embodiment.

FIGS. 4A, 4B is a chart diagram of the block diagram and the sensor signal concerning the first embodiment.

FIGS. 5A and 5B is a detail view concerning the first embodiment.

FIGS. 6A and 6B is a flowchart of the control concerning the first embodiment.

FIGS. 7A and 7B is a detail view showing the variation concerning the first embodiment.

FIG. 8 is a front view showing the phase detective configuration of the rotary concerning the second embodiment.

FIG. 9 is a right side elevation view showing the phase detective configuration of the rotary concerning the second embodiment.

FIGS. 10A and 10B is a chart diagram of a block diagram and a sensor signal concerning the second embodiment.

FIGS. 11A and 11B is a detail view of the sensor concerning the second embodiment.

### DESCRIPTION OF THE EMBODIMENT

### First Embodiment

### Color Electrophotographic Image Forming Apparatus

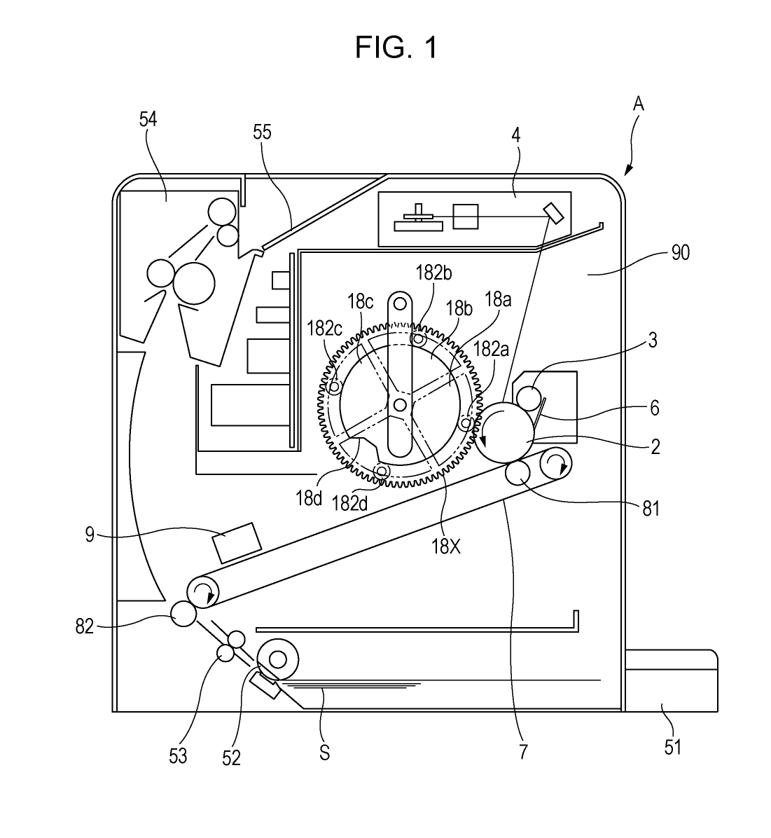

Color electrophotographic image forming apparatus concerning Example 1 will be described. Herein, as a color electrophotographic image forming apparatus, the color laser beam printer comprising four developing devices is exemplified. FIG. 1 is a sectional view of the color laser beam printer.

First, image forming operation of this color laser beam printer will be described.

As shown in FIG. 1, image forming apparatus A comprises electrophotographic photosensitive drum (explained as electrophotosensitive drum below) 2. Around electrophotosensitive drum 2, charging roller 3, exposure device 4, four developing devices 18a-18d and cleaning device 6 are located. Charging roller 3 corresponds to charging means for charging electrophotosensitive drum 2 equally. Exposure device 4 corresponds to exposure means to irradiate electrophotosensitive drum 2 with a laser beam depending on image information. Electrophotographic latent image is formed to electrophotosensitive drum 2 by irradiating the laser beam to electrophotosensitive drum 2 after the electrostatic charge. Developing device 18a-18d corresponds to developing means to develop and visualize the latent image formed in electrophotosensitive drum 2 using a developer of the corresponding color.

Developing device 18a accommodates a yellow developer. And developing device 18a is a yellow developing device for developing electrophotographic latent image with the yellow developer. Also, developing device 18b accommodates a magenta developer. And developing device 18b is a magenta developing device for developing electrophotographic latent image with the magenta developer. Developing device 18c accommodates a cyan developer. And developing device 18c is a cyan developing device for developing electrophotographic latent image with the cyan developer. Developing device 18d accommodates a black developer. And developing device 18d is a black developing device for developing electrophotographic latent image with the black developer. That is, developing device 18a-18d develop electrophotographic latent images formed on electrophotosensitive drum 2.

Cleaning device 6 corresponds to cleaning means to remove the developer remaining behind in the surface of electrophotosensitive drum 2.

First, electrophotosensitive drum 2 is synchronized with the rotation of intermediate transfer belt 7, and is rotated to the direction of the arrow (counterclockwise direction) in FIG. 1. And the front surface of the electrophotosensitive drum 2 is uniformly charged by charging roller 3. Further, in addition to the charging roller 3, the light irradiation of the yellow image is carried out by exposure device 4, and electrophotographic latent image of the yellow is formed to electrophotosensitive drum 2.

With the formation of this electrophotographic latent image, four developing device 18a-18d is detachably supported. And rotary 102 which is a rotatable rotary support is rotated by a drive transmission mechanism described below. And yellow developing device 18a is stopped at developing position 18X opposed to electrophotosensitive drum 2. At developing position 18X, developing roller 182a included in developing device 18a comes in contact with electrophotosensitive drum 2. Electrophotographic latent image is thereby developed in yellow developer. That is, rotary 102 moves a plurality of developing devices one by one to the developing position 18X which is opposed to the electrophotosensitive drum 2, by supporting the developing devices 18a-18d and rotating in the arrow direction r1. The developing device located in developing position 18X develops electrophotographic latent image depending on the color of the accommodated developer. Here, in the present embodiment, the elastic roller which rubber is coated around its metal axle is used as developing roller 182a-182d. It is noted that, in the present embodiment, each developing roller 182a-182d comes in contact with electrophotosensitive drum 2 in developing position 18X (contact developing method). Each developing roller 182a-182d develops the electrophotographic latent image in the state that came in contact with electrophotosensitive drum 2. However, the present invention is not limited to this configuration. The present invention is applicable to configuration where the developing at the latent image is performed with both close but not in contact at developing position 18X. Even in this configuration, an effect described below can be obtained.

Then the voltage of developer and opposite-polarity is applied to primary transfer roller 81 placed inside of transfer belt 7. Thereby, the yellow developer image formed in electrophotosensitive drum 2 is primary transferred to transfer belt 7.

As described above, the primary transfer of the yellow developer image is finished. And each of magenta, cyan, and black color developing device 18b-18d is sequentially rotated and moved by rotation of rotary 102. And each of the magenta, cyan and black color developing devices 18b-18d stops at developing position 18X opposed to electrophotosensitive drum 2. And, in the same case as yellow, formation, development and primary transfer are carried out sequentially for each colors, magenta, cyan and black. Four-colored developer image is thereby superimposed on transfer belt 7.

Secondary transfer roller 82 does not contact with transfer belt 7 during this period. Also, at this period, cleaning device 9 which removes a residual toner on transfer belt 7 does not contact transfer belt 7.

On the other hand, sheet S as a recording medium is stored in cassette 51 provided in the lower part of the main body of device 90. It is noted that, the recording medium, such as recording sheets and OHP sheets, forms developer images. Sheet S is separately fed one by one by feed roller 52 from cassette 51. And sheet S is fed to registration roller pair (conveyance roller) 53. Roller pair 53 sends the fed sheet S to the space between transfer belt 7 and transfer roller 82. Here, transfer roller 82 and transfer belt 7 are in an urged condition (a state shown in FIG. 1).

Even more particularly, the voltage having polarity opposite to that of the developer is applied to transfer roller 82. And, the four-colored developer image superimposed on transfer belt 7 is transferred (secondary transfer) at one time on the surface of the transported sheet.

Sheet S, to which developer image is transferred, is sent to fixing device 54. In fixing device 54, sheet S is heated and pressurized. And the developer image is fixed on sheet S. A color image is thereby formed on sheet S. And the sheet S is discharged from fixing device 54 to discharging portion of upper cover 55 outside the main body of device 90.

### [Drive Transmission Mechanism and Sensor]

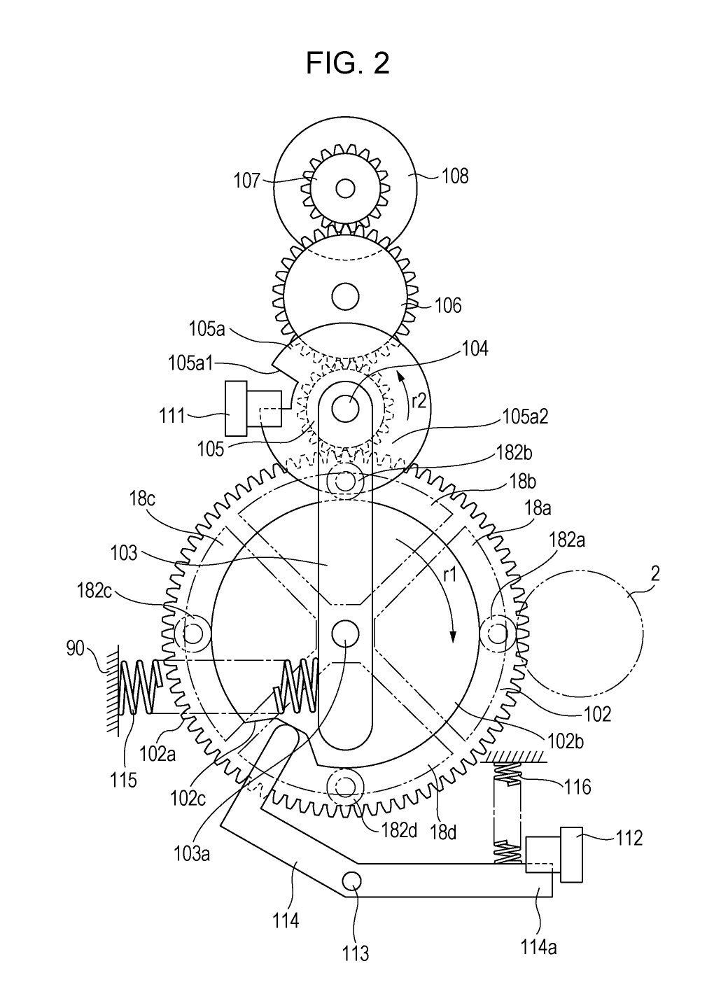

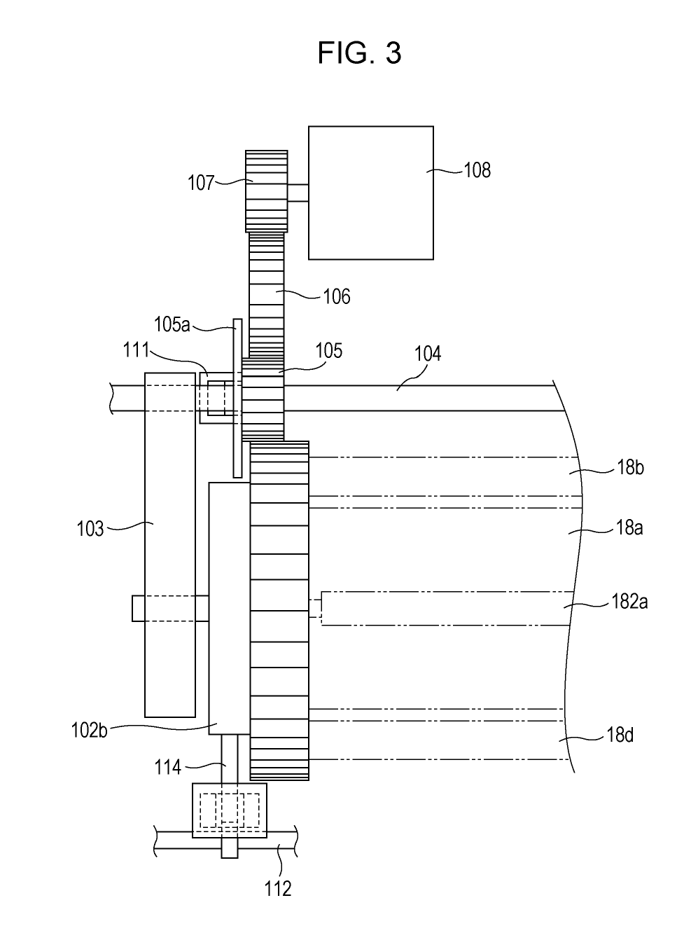

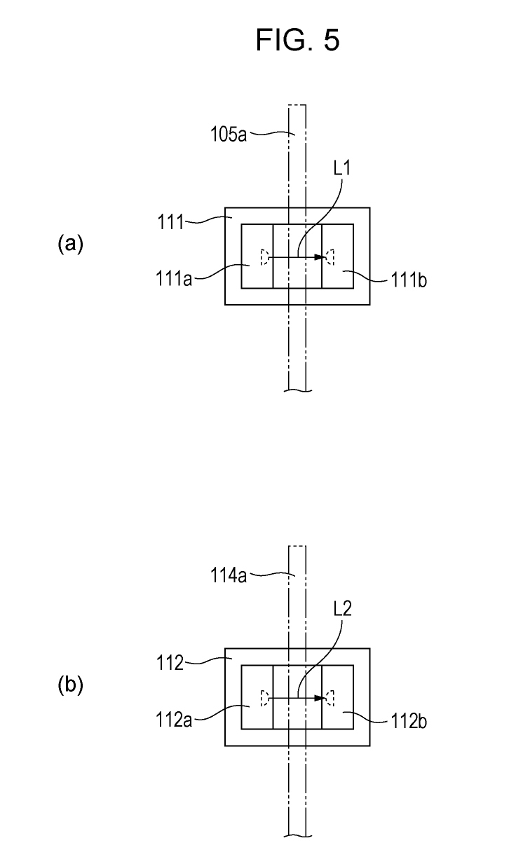

Here, using FIGS. 2 and 3, FIGS. 5A and 5B, drive transmission mechanism to rotate rotary 102 and a sensor are described. FIG. 2 is a front view which extracted a part of FIG. 1. FIG. 2 illustrates the conditions where developing roller 182a of developing device 18a is located at developing position 18X opposed to electrophotosensitive drum 2. FIG. 3 is a right side elevation view from the right direction of FIG. 2. It is noted that developing device 18a-18d and developing roller 182a-182d are shown in two-dot chain line. FIGS. 5A and 5B is a detailed view of a sensor.

Arm 103 is swingably supported mainly by drive shaft 104 rotatably supported by main body of device 90 rotatably. And arm 103 supports rotary 102 to be rotatable by rotation center 103a.

One end of arm spring 115 which is a compression spring is fixed to the main body of device 90. And, the other end of arm spring 115 is abutted to arm 103. And arm spring 115 produces power to push developing device 18a supported by rotary 102 in an appropriate pressure to electrophotosensitive drum 2. Idler gear 105 rotates mainly around drive shaft 104 in the arrow r2 direction.

And idler gear 105 has plate 105a which is the first cover detection member detected in sensor 111 which is the first detective sensor installed in the main body of device 90. Here, plate 105a is a flange integrally molded with idler gear 105. Sensor 111 is an optical sensor which comprises light department 111a for generating detective light and light receiving component 111b receiving the detective light generated by light department 111a. Plate 105a invades between projection of the light department 111a and light receiving component 111b. Plate 105a comprises shading department 105a1 which shades the light from optical path L1 of the detective light, and opening region 105a2 which is the notch region which opens optical path L1. Herein, an example of plate 105a comprised integrally by idlear gear 105 is described. But plate 105a may be anything rotating with idlear gear 105, even if plate 105a is independently formed from idlear gear 105.

Also, idler gear 105 engages with gear part 102a which is provided outside rotary 102. And idler gear 105 transmits rotatory power of motor 108 to rotary 102. Here, the number of the teeth of gear part 102a is defined 4 times larger than idler gear 105. In other words, when idler gear 105 rotates one lap, rotary 102 makes a quarter rotation in the arrow r1 direction. And rotary 102 rotates one lap in the arrow r1 direction if idler gear 105 rotates four laps.

Stepper motor 108 can rotate rotary 102 through pinion gear 107, idler gear 106 and idler gear 105. Here, a stepper motor is used. However, the DC motors comprising the pulse encoder which can control rotary phase can be used. And an effect described below can be obtained even if an electromagnetic clutch or other devices which can intercept driving force is provided.

Detective arm 114 which is the second cover detection member is rotatably supported by rotation fulcrum 113 installed in main body of device 90. And detective arm 114 receives pressing force by spring 116 which is a compression spring. And detective arm 114 is abutted to cam part 102b provided in rotary. Also, one end of detective arm 114 is detected by sensor 112 which is the second detective sensor installed in main body of device 90. Sensor 112 comprises integrally light generating unit 112a projecting detective light shown in FIG. 5(b) and light receiving unit 112b receiving detective light generated from light generating unit 112a. Detective arm 114 is inserted between projection of the light generating unit 112a and light receiving component 112b. One end of detective arm 114 has shading department 114a which can shade the light in optical path L2 of the detective light.

### [Control Unit]

In main body of device 90, CPU 83, which is a control unit for controlling the rotation of motor 108 based on the first signal output from sensor 111 and the second signal output from sensor 112, is provided.

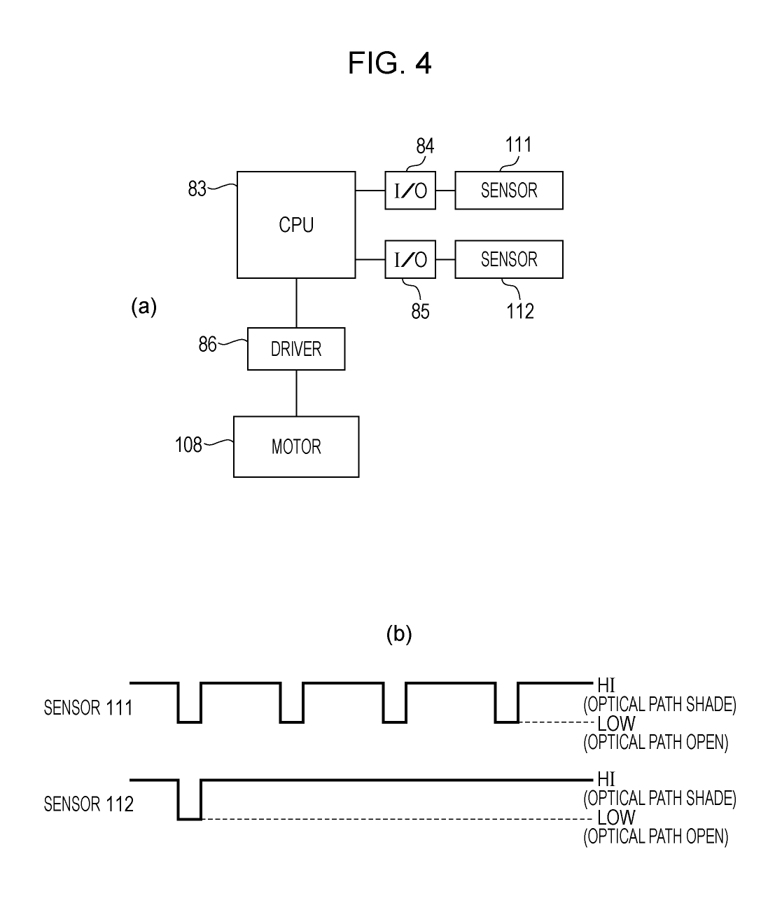

As shown in FIG. 4A, CPU 83 is electrically connected with I/O circuit 84 through sensor 111. The detective light is emitted from light generating unit 111a by control from CPU 83. A signal by detective light subjected to light in light receiving unit 111b is received. As shown in FIG. 4B the voltage value becomes HI state (e.g., 5V) when sensor 111 shades the light in optical path L1. The voltage value is set to be in LOW state (e.g., OV) in I/O circuit 84 and 85 when sensor 111 opens optical path L1. The CPU 83 is electrically connected with driver 86 through motor 108. And the CPU 83 controls the rotation of motor 108.

In this embodiment, idler gear 105 is engaged with gear unit 102a such that developing roller 182a of yellow developing device 18a abuts electrophotosensitive drum 2 in a moment when sensor 111 detects opening unit 105a2 provided in plate 105a. As described earlier, the number of the teeth of gear part 102a is 4 times of the number of the teeth of idler gear 105. Therefore opening unit 105a2 will be detected by sensor 111 when each developing roller 182a-182d are abut to electrophotosensitive drum 2 if developing roller 18a-18d are supported in equal distance to rotary 102. By this, it is recognizable that each developing roller 182a-182d abuts with electrophotosensitive drum 2.

However, CPU 83 cannot recognize what color of developing roller is abutting. Thus reentrant 102c is provided in cam part 102b to detect predetermined phase of rotary 102. For example, detective arm 114 is dropped to the reentrant 102c near the position where developing roller 182a abuts with electrophotosensitive drum 2 before sensor 111 reacts. Even more particularly, the optical path of sensor 112 is opened only when detective arm 114 dropped in reentrant 102c. As for the other time, it is set to shade out the optical path of sensor 112 with shading department 114a. That is, the role of second detective sensor 112 is to detect whether rotary 102 is at a predetermined phase position or at a phase position other than the predetermined phase position.

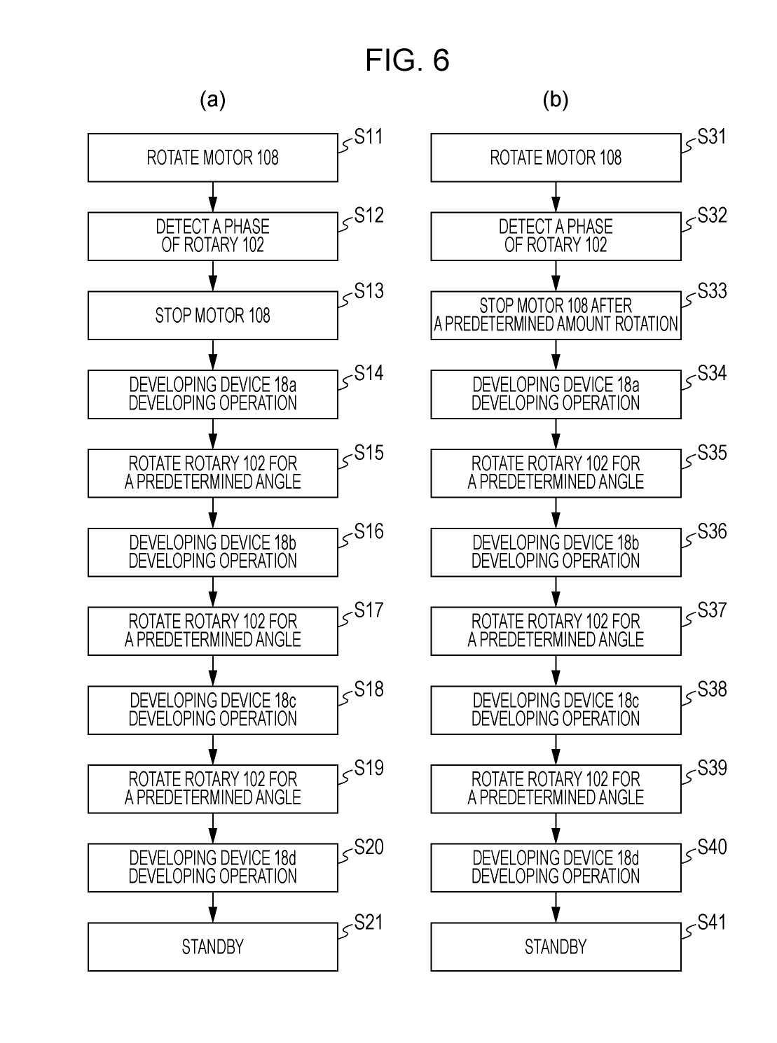

The CPU 83 can recognize that yellow developing roller 182a abuts electrophotosensitive drum 2 when sensor 111 opens optical path L1 and sensor 112 opens optical path L2 as shown in FIG. 4B. That is, it is recognized that yellow developing roller 182a abuts with electrophotosensitive drum 2 when motor 108 is rotated as shown in flowchart of FIG. 6A (S11) and when the signal of sensor 111 and sensor 112 are both Low state (S12). The rotary 102 is stopped (S13). Then after developing operation is performed in developing device 18a(S14), the number of the pulses oscillating to pulse motor 108 is controlled by driver 86 based on the information of the phase of the rotary 102 (S15). Thereby, each of the other developing device 18b-18d is transported to developing position 18X. It is possible to stop at developing position 18X (S17, S19). Each developing rollers 182b-182d is abutted to electrophotosensitive drum 2. The operation (i.e., S16, S18, S20) to develop electrophotographic latent image is performed.

Here, as described above, plate 105a rotates 4 times when rotary 102 rotates once. Thus, compared to the case of a flag detected by a sensor in the distance of radius “a” of rotary 102, if the radius of plate 105a is “a”, the phase of rotary 102 may be temporarily detected by quarter of error. Also, for instance, compared to the conventional case of a flag detected by a sensor in the distance of radius 2a of rotary 102, if the radius of plate 105a is a, the phase of rotary 102 can be temporarily detected by half of error. That is, the flag to the distance of radius 4a in rotary 102 is provided when the detective accuracy that is equal to the detective accuracy of this embodiment is implemented in the system that provided the flag in rotary 102. And big space may be used for the flag to rotate. Mentioning an general relation, when the maximum radius of rotary 102 is d1, and the radius of plate 105a is d2, and when plate 105a rotates n times (rotary ratio n), if the relation of

d2>d1/n

is satisfied, accuracy of detection of rotary 102 can be improved.

Here, temporarily, the maximum radius of rotary 102 is the distance where the flag detected by a sensor by rotary 102 can be set from the center of the rotation. The radius of plate 105a is the detected member of plate 105a detected by sensor 111.

Thus, by the configuration of this embodiment, detection can be made with smaller size and with more high dimensional accuracy than the conventional.

Also, in the present embodiment, opening unit 105a2 is detected by sensor 111 at the moment when developing roller 182a abut to electrophotosensitive drum 2. However, it can be anywhere. For example, opening unit 105a2 is detected at a position 10 degrees before a phase of rotary 102 when developing roller 182a abuts to electrophotosensitive drum 2 by sensor 111. If reentrant 102c is set for color detection lever 114 sets to fall into reentrant 102c near the phase of rotary 102 and also before sensor 111 reacts, CPU 83 can detect the phase of rotary 102 accurately. A flow chart of this time is shown in FIG. 6B. However, the only thing different from FIG. 6A is step 33, previously described. That is, CPU 83 may control motor 108 and rotate rotary 102, from the detected phase to the phase of developing roller 18a of developing device 182a abutting with electrophotosensitive drum 2 (S33). The other control is the same as the flow chart of FIG. 6A.

Also, the number of the teeth of gear unit 102a is a multiple of 4 of the teeth of idler gear 105 in the present embodiment. However, the number of the teeth of gear unit 102a may be a multiple of natural number n in the present embodiment. For example, if the number of teeth of gear part 102a is 10 times larger than that of idler gear 105, rotary 102 does 1/10 lap when idler gear 105 does 1 lap. In other words, whenever rotary 102 performs 1/10 lap, opening department 105a2 passes the light to sensor 111. And idler gear and gear region 102a are set in so that the phase of rotary 102 is detected with certainty in a moment when opening unit 105a2 is detected by sensor 111. And, in addition, if color detection lever 114 is set to fall into reentrant 102c near the phase of rotary 102 and also before sensor 111 react, main body device 90 can detect the phase of rotary 102 accurately based on the signal output from sensor 111 and sensor 112. And the number of oscillation pulse to pulse motor 108 can be controlled. And developing roller 182a-182d can be moved sequentially and stopped at developing position 18X. And abutting to electrophotosensitive drum 2 is possible. However, it is not applicable when the number of the teeth of gear part 102a is not a multiple of natural number n of the number of the teeth of idler gear 105. When it is not multiple of natural number n, it is easy to imagine that the phase of rotary 102 when opening department 105a2 is detected by sensor 111 is not constant. Opening department 105a2 is detected by sensor 111 at the time of the phase of rotary 102 only when it is multiple of natural number n.

### Other Embodiments

Also, in the present embodiment, plate 105a detected by sensor 111 is provided to idler gear 105, but it may be provided anywhere on the drive line from the driving source driving rotary 102. However, the condition that the rotary 102 rotates 1/n (in n natural number) when a gear comprising plate 105a or a pulley rotates 1 revolution is to be satisfied.

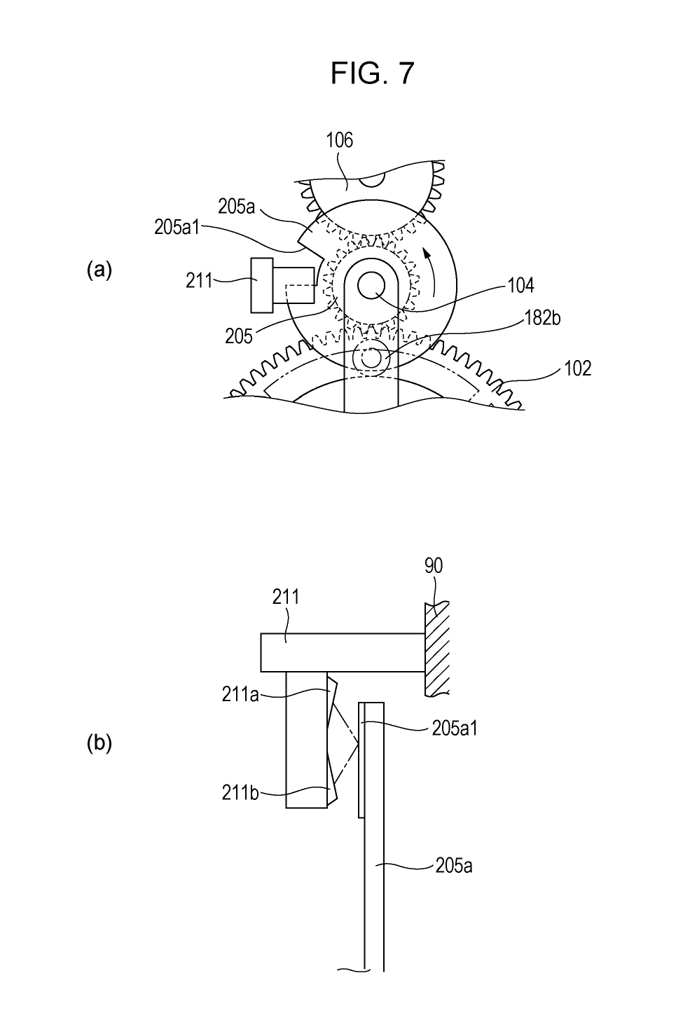

Also, in the present embodiment, an example showing that plate 105a comprises shading department 105a1 which shades the optical path of the detective light and opening region 105a2 which is a cutout region which opens the optical path L1. However, as shown in FIGS. 7A and 7B, plate 205a may comprise reflection department 205a1 which reflects the detective light. In this case, sensor 211 comprises light department 211a of the detective light and receiving component 211b on the same side. Plate 205a rotates in the arrow r2 direction. And the detective light generated by light department 211a reflects when reflection department 211ab comes. And detective light is received in light receiving component 211b.

Also, in the present embodiment, plate 105a which is the first detective member engages with gear part 102a which is provided outside rotary 102. However, it is not limited to the combination by the gear. It may be anything which engages with rotary 102, such as friction wheel, belt, and pulley. Thus, phase of rotary 102 can be controlled with smaller size and with higher dimensional accuracy than the case when the flag is set directly to rotary 102.

### Second Embodiment

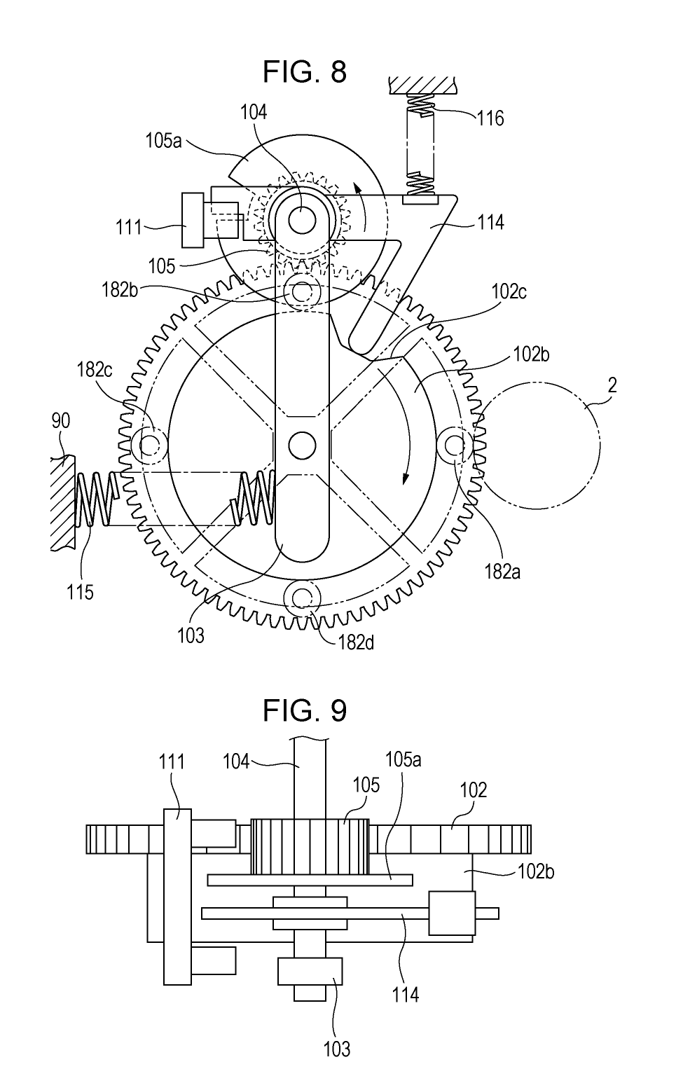

A figure which extracts a rotary part of a color laser beam printer comprising Embodiment 2 is shown in FIG. 8-FIG. 9. FIG. 8 is a front view and FIG. 9 is a top view.

The present embodiment performed detection of plate 105a and detective arm 114 only be sensor 111 compared to embodiment 1. Thus, as well as an effect of embodiment 1, there is a benefit that it is possible to omit one sensor.

Idler gear 105 makes a similar operation as embodiment 1. And the number of the teeth of gear part 102a is a multiple of natural number n of idler gear 105. Here, it is assumed as 4 times for the convenience of explanation. Plate 105a comprises shading department 105a1 shading optical path L1 of detective light as well as embodiment 1 and opening unit 105a2 which is a notch unit opening optical light L1. Detection lever 114 is rotatably supported by drive shaft 104. Shading part 114a which can shade the light in optical path L1 of the detective light is comprised in one end of detective arm 114. And by being pressed by detection lever which the other end is supported by device main body 90, it abuts to cam part 102b. Also, only when detection lever 114 dropped in reentrant 102 c, shading department 114a opens optical path L1 of the detective light.

Here, as well as embodiment 1, at the moment when opening department 105a2 provided in plate 105a is detected by sensor 111, idler gear 105 and gear unit 102a is engaged so that developing roller 182a of yellow developing device 18a abuts to electrophotosensitive drum 2. And reentrant 102c is provided for opening optical path L1 near developing roller 182a abutted to electrophotosensitive drum 2 and also before sensor 111 detects opening unit 105a2.

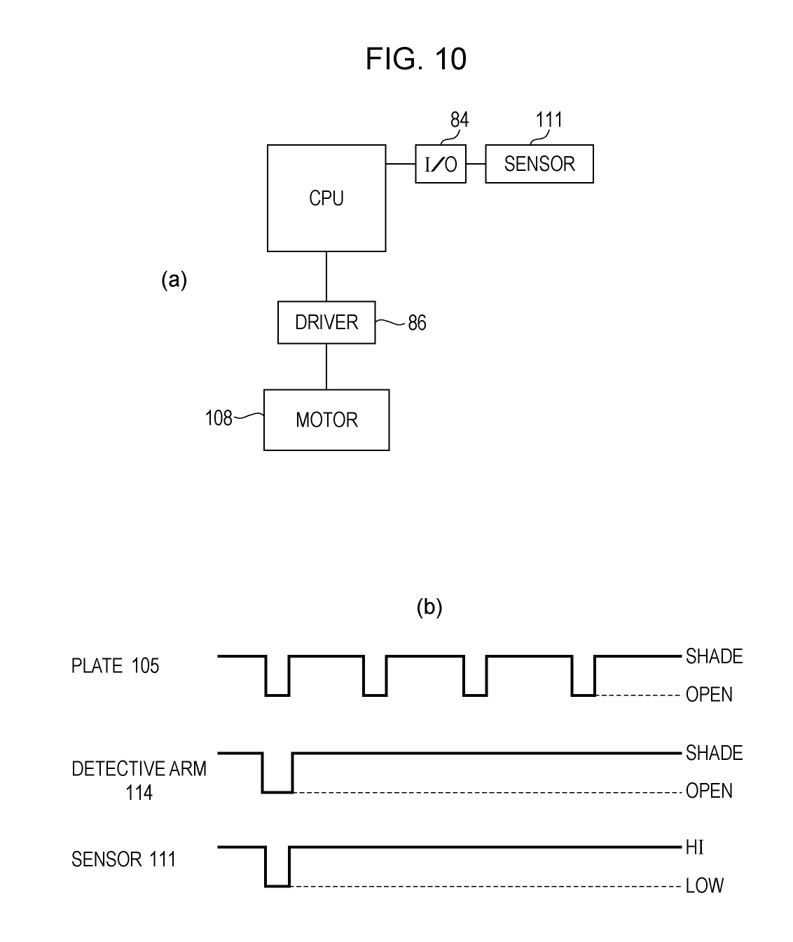

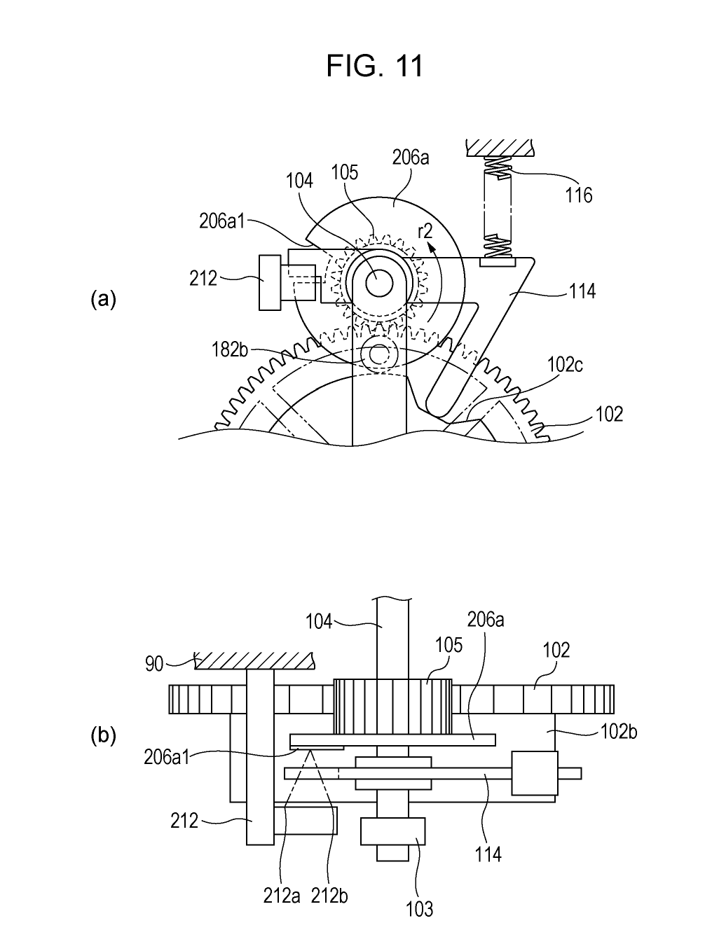

Thus, in embodiment 2, optical path L1 is opened only when developing roller 182a of yellow developing device 18a abut to electrophotosensitive drum 2 as shown in FIG. 10B. Thus, CPU 83 shown in FIG. 10A recognizes through I/O circuit 84 that voltage value of sensor 111 is in LOW state (e.g., 0V). When a developing device besides yellow developing device 18a comes to the developing position, CPU 83 recognizes through I/O circuit 84 that voltage value of sensor 111 is in HI state (ex. 5V) because optical path L1 is in condition to have been shaded the light as shown in FIGS. 11A and 11B.

And CPU 83 determines that yellow developing roller 182a abut to electrophotosensitive drum 2 when a signal of sensor 111 is in LOW state. Based on this information, by controlling the number of pulse output to pulse motor 108 by driver 86, each developing device 18a-18d is transported to developing position 18× and stopping at developing position is possible as shown in FIG. 10A. Each developing roller 182a-182d is abutted to electrophotosensitive drum 2 and the movement to develop electrophotographic latent image is performed.

Also, in the present embodiment, an example of plate 105a comprising by shading unit 105a1 shading optical path L1 of detective light and opening unit 105a2 which is a notch region opening optical path L1 is mentioned. However, as well as embodiment 1, as shown in FIGS. 11A and 11B, plate 206 may comprise reflection unit 206 reflecting the detective light. In this case, as for sensor 212, projection of light department 212a and light receiving component 212b of detective light is comprised on the same side like FIG. 11B. The detective light emitting light in light unit 212a reflects when reflection unit 206a1 comes. The detective light is received in light receiving component 212b. Thus, optical light L1 is opened by shading unit 114a only when developing roller 182a of yellow developing unit 18a abut to electrophotosensitive drum 2. The detective light is reflected in reflection department 206a light is received in light receiving unit. CPU 83 judges that yellow developing roller 182a abut to electrophotosensitive drum 2 when signal of sensor 111 is in Low state.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An color electrophotographic image forming apparatus for forming an image on a recording medium comprising:
a photosensitive member forming an electrostatic latent image;
a rotary support configured to support a plurality of developing devices for developing the electrostatic latent image, and to move a developing device to a developing position for developing the electrostatic latent image by rotation;
a first member configured to rotate multiple times of natural number when the rotary support rotates once moving together with the rotary support, a rotation of the first member being detected by a first sensor;
a second member configured to move together with the rotary support, the rotary support member being detected to be positioned at a predetermined phase by a second sensor; and
a controlling unit configured to detect a phase of the rotary support by a first signal to be output from the first sensor having detected the first member, and a second signal to be output from the second sensor having detected the second member.

2. The color electrophotographic image forming apparatus according to claim 1, wherein the controlling unit performs controlling such that the developing device is stopped at the developing position after detection of the phase of the rotary support.

3. The apparatus according to claim 1, wherein the first member is configured such that one rotation of the first member is detected by the first detecting sensor at the position where the developing device is at the developing position.

4. The color electrophotographic image forming apparatus according claim 1, further comprising a drive source configured to drive the rotary support, wherein the first member rotates integrally with a first gear transmitting a drive force from the drive source to a second gear formed on a peripheral portion of the rotary support.

5. The color electrophotographic image forming apparatus according to claim 1, wherein the first member rotates with the first gear engaging with the second gear.

6. The color electrophotographic image forming apparatus according to claim 1, wherein the first sensor includes:
a projecting unit configured to project detective light;
a receiving unit configured to receive the detective light;
wherein the first member includes a light shielding unit configured to shield a light path of the detective light and an opening unit configured to open the light path.

7. The color electrophotographic image forming apparatus according to claim 1, wherein the first sensor includes:
a light projecting unit configured to project detective light;
a light receiving unit configured to receive the detective light;
wherein the first member includes a reflecting portion reflecting the detective light to the light receiving unit.

8. The color electrophotographic image forming apparatus according to claim 1, wherein the rotary support supports a yellow developing device including a yellow developer, a magenta developing device including a magenta developer, a cyan developing device including a cyan developer, a black developing device including a black developer, and
wherein the first member rotates in multiple times of 4 when moving together with the rotary support and when the rotary support rotates once.

9. The color electrophotographic image forming apparatus according to claim 8, wherein the predetermined phase is a phase in a case where one of the plurality of developing devices is at the developing position.

10. The color electrophotographic image forming apparatus according to claim 9, wherein the predetermined phase is the phase in a case where the yellow developing device is in the developing position.

11. The color electrophotographic image forming apparatus according to claim 1, wherein d1 demotes a radius from a rotational center of the rotary support, and
wherein d2 denotes a radius from a rotational center of the first member, and
wherein in a case where the first member rotates a natural n number of times when the rotary support rotates once, a relation of d2>d1/n is satisfied.

12. An color electrophotographic image forming apparatus for forming an image on a recording medium comprising:
a photosensitive member for forming an electrostatic latent image;
a rotary support configured to support a plurality of developing devices for developing the electrostatic latent image, and to move a developing device to a developing position for developing the electrostatic latent image by rotation;
a sensor comprising a light projecting unit configured to project detective light and a light receiving unit configured to receive the detective light;
a first member configured to rotate multiple times of natural number of times when moving together with the rotary support and when the rotary support rotates once, a rotation of the first member being detected by the sensor;
a second member configured to move together with the rotary support, to open a light path of the sensor when the rotary support is at a position of the predetermined phase, and to shield the light path when the rotary support is at a position other than the predetermined phase; and
a controlling unit configured to detect a phase of the rotary support by a signal output from the sensor having detected the first detected member when the light path is opened by the second member.

13. The color electrophotographic image forming apparatus according to claim 12, wherein the controlling unit controls to stop the developing device at the developing position after detection of a phase of the rotary support is performed.

14. The color electrophotographic image forming apparatus according to claim 12, wherein the rotation of the first member is detected by the sensor at the position where the developing device supported by the rotary support is at the developing position.

15. The color electrophotographic image forming apparatus according to claim 12, further comprising a drive source configured to drive the rotary support,
wherein the first member rotates integrally with a first gear transmitting drive force from the drive source to a second gear formed on a peripheral portion of the rotary support.

16. The apparatus according to claim 12, wherein the first member rotates with the first gear engaging with a second gear.

17. The color electrophotographic image forming apparatus according to claim 12,
wherein the first member includes a light shielding unit configured to shield a light path of the detective light and an opening unit configured to open the light path.

18. The color electrophotographic image forming apparatus according to claim 12,
wherein the first member includes a reflecting portion reflecting the detective light to the receiving unit.

19. The color electrophotographic image forming apparatus according to claim 12, wherein the rotary support supports detachably a yellow developing device including a yellow developer, a magenta developing device including a magenta developer, a cyan developing device including a cyan developer, a black developing device including a black developer, and
wherein the first member rotates only multiple times of 4 when the rotary support rotates once when moving together with the rotary support.

20. The color electrophotographic image forming apparatus according to claim 19, wherein the predetermined phase is a phase in a case where one of the plurality of developing devices is at the developing position.

21. The color electrophotographic image forming apparatus according to claim 20, wherein the predetermined phase is the phase in a case where the yellow developing device is in the developing position.

22. The color electrophotographic image forming apparatus according to claim 12, wherein d1 demotes a radius from a rotational center of the rotary support, and
wherein d2 denotes the radius from the rotational center of the first member, and
wherein in a case where the first member rotates natural number of times when the rotary support rotates once, a relation of
d2>d1/n
is satisfied.
